(19) United States
(12) Patent Application Publication
(10) Pub. No.: US 2008/0226834 A1
(43) Pub. Date: Sep. 18, 2008

(54) UV CURABLE INK COMPOSITIONS

(75) Inventor: Roy C. Krohn, Kimball, MI (US)

Correspondence Address: BROOKS KUSHMAN P.C., 1000 TOWN CENTER, TWENTY-SECOND FLOOR, SOUTHFIELD, MI, 48075, US

(73) Assignee: ALLIED PHOTOCHEMICAL, INC., Marysville, MI (US)

(21) Appl. No.: 12/111,754

(22) Filed: Apr. 29, 2008

Related U.S. Application Data
(63) Continuation of application No. 11/027,329, filed on Dec. 30, 2004, now abandoned.
(60) Provisional application No. 60/533,453, filed on Dec. 30, 2003.

(51) Int. Cl. C08J 3/28; C09D 11/10; C08L 67/00

(52) U.S. Cl. 427/514; 522/149

(57) ABSTRACT

A UV curable ink composition that comprises a ultraviolet light curable ink composition comprising at least one acrylated oligomer, a pigment, and a photoinitiator is provided. The ink composition of the present invention has a viscosity from about 300 centipoise at 25° C. to about 10000 centipoise at 25° C. In one variation the at least one acrylated oligomer includes an aliphatic acrylated urethane oligomer and an epoxy oligomer. In another variation the ink composition includes an acrylic oligomer.

### CROSS-REFERENCE TO RELATED APPLICATIONS

This application is a continuation of U.S. Ser. No. 11/027,329 filed Dec. 30, 2004, which claims the benefit of U.S. provisional application Ser. No. 60/533,453 filed Dec. 30, 2003; the entire disclosures of these applications are hereby incorporated by reference.

### BACKGROUND OF THE INVENTION

1. Field of the Invention

The present invention relates to UV curable ink compositions and to methods of applying such compositions to a substrate.

2. Background Art

Many printing applications such as the printing of beverage containers utilize heat curable compositions. In these applications, the desired text or logo is applied to a substrate and then thermally cured. Typically, such heat curable compositions require the use of organic solvents that contain a significant amount of volatile organic compounds (VOCs). These VOCs escape into the atmosphere while the heat curable coating dries. Such solvent based systems are undesirable because of the hazards and expenses associated with VOCs. The hazards include water and air pollution and the expenses include the cost of complying with strict government regulation on solvent emission levels. In contrast, UV curable compositions contain reactive monomers instead of solvents; thus eliminating the detrimental effects of the VOCs.

UV curable coatings are cured through rapid photo-induced polymerizations instead of thermal energy which releases VOCs into the atmosphere. Since the UV curing process is essentially solvent free, the necessity for time consuming and expensive pollution abatement procedures is greatly reduced.

UV curable coatings offer several other benefits not associated with thermally cured coatings. First, faster cure times offer substantial economic benefits. Furthermore, heat sensitive materials can be safely coated and cured with UV light without thermal degradation of heat sensitive substrates. Additionally, UV light is a relatively low cost of energy due to its widespread availability.

Accordingly, there exists a need to provide environmentally safe UV curable ink compositions which exhibit improved performance. Additionally, there is a need to provide a method of applying an improved composition which furthers the goal of improved performance.

### SUMMARY OF THE INVENTION

The present invention overcomes the problems encountered in the prior art by providing in a first embodiment, a UV curable ink composition that includes less than about 5% volatile organic compounds. The ink composition of the present invention comprises a photocurable organic composition comprising at least one acrylated oligomer; an optional pigment; and a photoinitiator. The ultraviolet curable ink composition of the present invention has a viscosity from about 300 centipoise at 25° C. to about 10000 centipoise at 25° C. The ink compositions of this embodiment can be made in virtually any color. Moreover, these ink compositions adhere to a variety of different substrates which include plastics, metals, chloroplast, vinyls, anti-static materials, glass, PVC, and the like with superior adhesion and gloss retention properties when compared to solvent based systems. The ink compositions of the invention are particularly useful for decorative printing on aluminum cans such as those used in the beverage industry.

In another embodiment of the invention, a UV curable ink composition that includes an acrylic oligomer is provided. The composition of this embodiment comprises a photocurable organic composition comprising at least one acrylic oligomer, a pigment, and a photoinitiator. The photocurable organic composition includes a polymeric ester resin diluted with a monomer. The ink composition of this embodiment also includes less than about 5% volatile organic compounds. The ink compositions of this embodiment can be made in virtually any color. Moreover, these ink compositions adhere to a variety of different substrates which include plastics, metals, chloroplast, vinyls, anti-static materials, glass, PVC, and the like.

In yet another embodiment of the invention, a method of applying the ink compositions of the invention is provided. The method of the invention includes applying the ink composition to the substrate followed by illumination with ultraviolet light at a suitable intensity and time duration to effect curing of the ink composition.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventor.

The term “polymer” as used herein refers to a molecule of relatively high molecular mass made up by the repetition of a simpler molecule of low relative molecular mass.

The term “degree of polymerization” as used herein refers to the number of repeating simpler molecules.

The term “oligomer” as used herein refers to a molecule of intermediate molecular mass. Oligomers often comprise a small plurality of lower molecular mass molecule. Moreover, oligomers will typically have a degree of polymerization from 2 to 20.

The term “polyurethane” are used herein refers to polymers containing urethane groups (—NH—CO—O—) typically created by reacting isocyanates with polyols and chain extenders.

The term “aliphatic” as used herein refers to nonaromatic saturated or unsaturated linear or branched hydrocarbon group which includes for example alkyl, alkenyl, and alkynyl groups.

The term “acrylated” as used herein refers to monoacrylated, monomethacrylated, multi-acrylated, and multi-methacrylated monomers, oligomers and polymers.

### UV Curable Ink Compositions

In accordance with one aspect of the invention, a presently preferred ultraviolet light curable ink composition (“ink composition”) is provided. Moreover, the ink compositions of the invention are fluid phase compositions. The ink composition of the present invention comprises a photocurable organic composition comprising at least one acrylated oligomer or an acrylic oligomer, an optional pigment, and a photoinitiator. The ultraviolet curable ink composition typically has a viscosity from about 300 centipoise at 25° C. to about 10000 centipoise at 25° C. The ink compositions of this embodiment are capable of forming coatings with superior adhesion and gloss retention properties. For examples, coating made with the compositions of the invention have shown less than a 10% loss of gloss upon heating to 400° F. for about 20 minutes while solvent based and conventional UV curable compositions perform worse. Moreover, values as low as a 7% loss of gloss under these conditions for the compositions of the invention has been achieved.

In a first embodiment of the present invention the photocurable organic composition includes at least one acrylated oligomer selected from the group consisting of an acrylated epoxy oligomer, an acrylated polyester oligomer, acrylated silicone oligomer, acrylated acrylic oligomer, acrylated urethane oligomer, an acrylated melamine oligomer, and mixtures thereof. More preferably, the photocurable organic mixture includes an acylated urethane oligomer and an acrylated epoxy oligomer. Most preferably, the photocurable organic mixture includes an acrylated aliphatic urethane oligomer and an epoxy oligomer.

As set forth above, in variations of the invention, the photocurable organic mixture of the ink composition includes at least one acrylated urethane oligomer which is typically an aliphatic acrylated oligomer (i.e., an aliphatic acrylated urethane oligomer). In a variation, the at least one acrylated urethane oligomer is present in an amount from about 5% to 95% of the total weight of the ink composition. Unless specifically stated, all percentages are weight percentages of the total weight of the ink composition. In another variation, the at least one acrylated urethane oligomer is present in an amount from about 10% to 50% of the total weight of the ink composition. In yet another variation, the at least one acrylated urethane oligomer is present in an amount from about 20% to about 35% of the total weight of the ink composition. In still another variation, the at least one acrylated urethane oligomer is present in an amount of about 30% of the total weight of the ink composition. Suitable aliphatic acrylated urethane oligomers include Radcure Ebecryl 244 (aliphatic urethane diacrylate diluted 10% by weight with 1,6-hexanediol diacrylate), Ebecryl 264 (aliphatic urethane triacrylate diluted 15% by weight with 1,6-hexanediol diacrylate), Ebecryl 284 (aliphatic urethane diacrylate diluted 12% by weight with 1,6-hexanediol diacrylate) urethanes, Ebecryl 8807 (an aliphatic urethane diacrylate) and RX 01336 (an aliphatic urethane diacrylate which is a homopolymer); commercially available from Radcure UCB Corp. of Smyrna, Ga.; Sartomer CN-961E75 (aliphatic urethane diacrylate blended with 25% by weight ethoxylated trimethylol propane triacylate), CN-961H81 (aliphatic urethane diacrylate blended with 19% by weight 2(2-ethoxyethoxy)ethyl acrylate), CN-963A80 (aliphatic urethane diacrylate blended with 20% by weight tripropylene glycol diacrylate), CN-964 (aliphatic urethane diacrylate), CN-966A80 (aliphatic urethane diacrylate blended with 20% by weight tripropylene glycol diacrylate), CN-982A75 (aliphatic urethane diacrylate blended with 25% by weight tripropylene glycol diacrylate) and CN-983 (aliphatic urethane diacrylate), commercially available from Sartomer Corp. of Exton, Pa.; TAB FAIRAD 8010, 8179, 8205, 8210, 8216, 8264, M-E-15, UVU-316, commercially available from TAB Chemicals of Chicago, Ill.; and Echo Resin ALU-303, commercially available from Echo Resins of Versaille, Mo.; and Genomer 4652, commercially available from Rahn Radiation Curing of Aurora, Ill. Ebecryl 264 is an aliphatic urethane triacrylate of 1200 molecular weight supplied as an 85% solution in hexanediol diacrylate. Ebecryl 284 is aliphatic urethane diacrylate of 1200 molecular weight diluted 10% with 1,6-hexanediol diacrylate. Combinations of these materials may also be employed herein. The preferred acrylated urethane oligomer comprises Ebecryl 8807 and RX 01336.

Also as set forth above, the photocurable mixture further includes an epoxy oligomer. Typically, the epoxy oligomer is an acrylated epoxy oligomer. In a variation of this embodiment, the acrylated epoxy oligomer is present in an amount from about 1% to 30% of the total weight of the ink composition. In another variation of the invention, the acrylated epoxy oligomer is present in an amount from about 5% to 25% of the total weight of the ink composition. Suitable acrylated epoxy oligomers include Radcure Ebecryl 3603, commercially available from Radcure UCB Corp.; Sartomer CN120 and CN124, commercially available from Sartomer Corp.; and Echo Resin TME 9310 and 9345, commercially available from Echo Resins. Suitable epoxy oligomers are acrylated epoxy novolac resins. The preferred acrylated epoxy oligomer is Ebecryl 3603, which novalac epoxy acrylate (a trifunctional acrylate) diluted 20% with tripropylene glycol diacrylate. Combinations of these materials may also be employed herein.

The weight percentages of the acrylated urethane oligomer and the epoxy oligomer are limited by the requirement that the ink compositions of the invention have a viscosity from about 300 centipoise at 25° C. to about 10000 centipoise at 25° C. This requirement simultaneously imposes simultaneous requirements on the weight percentages and the viscosities of each of these components. In other variations of the invention these requirements are even stricter with the ink having a viscosity from about 1000 centipoise at 25° C. to about 10,000 centipoise at 25° C. In yet another variation of the invention, the ink compositions have a viscosity from about 2500 centipoise at 25° C. to about 7000 centipoise at 25° C. In still another variation of the invention, the ink compositions have a viscosity from about 3500 centipoise at 25° C. to about 6000 centipoise at 25° C.

The UV curable ink composition of this embodiment also includes an ethylenically unsaturated monomer having Formula I:

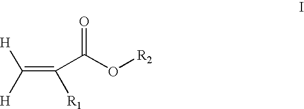

wherein R₁ is hydrogen or substituted or unsubstituted alkyl; and R₂ is substituted or unsubstituted alkyl having more than 4 carbon atoms, cycloalkyl, cycloalkenyl, or substituted or unsubstituted aryl. Preferably R₁ is hydrogen or methyl; and R₂ is isobornyl, phenyl, benzyl, dicylcopentenyl, dicyclopentenyl oxyethyl, ethylene glycol dicyclopentyl ether, cyclohexyl, and naphthyl. The most preferred ethyleneically unsaturated monomers are isobornyl acrylate monomers. The amount of ethylenically unsaturated monomer is such that viscosity of the ink composition is between 1000 centipoise at 25° C. and 10,000 centipoise at 25° C. In yet another variation of the invention, the amount of ethylenically unsaturated monomer is such the ink composition has a viscosity from about 2500 centipoise at 25° C. to about 7000 centipoise at 25° C. In still another variation of the invention, the amount of ethylenically unsaturated monomer is such the ink composition has a viscosity from about 3500 centipoise at 25° C. to about 6000 centipoise at 25° C. In a variation of the invention, the ethylenically unsaturated monomer (an in particular the isobornyl acrylate monomer) is present in an amount from about 0.1% to 60% of the total weight of the ink composition. In another variation of the invention, ethylenically unsaturated monomer (and in particular, the isobornyl acrylate monomer) is present in an amount from about 20% to 40% of the total weight of the ink composition. In yet another variation, the ethylenically unsaturated monomer is present in an amount of about 30% of the total weight of the ink composition. Suitable isobornyl acrylate monomers include Sartomer SR-423 (isobornyl methacrylate):

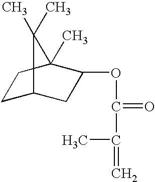

and SR-506 (isobornyl acrylate):

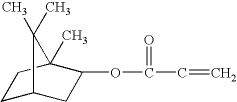

The ink composition of this embodiment also includes a photoinitiator in an amount from about 1% to 15% of the total weight of the ink composition of the ink composition. In a variation of the invention, the photoinitiator is present in an amount from about 4% to 12% of the total weight of the ink composition. In another variation of the invention, the photoinitiator is present in an amount of about 8% of the total weight of the ink composition. Suitable photoinitiators include Irgacure 184 (1-hydroxycyclohexyl phenyl ketone), Irgacure 907 (2-methyl-1-[4-(methylthio)phenyl]-2-morpholino propan-1-one), Irgacure 369 (2-benzyl-2-N,N-dimethylamino-1-(4-morpholinophenyl)-1-butanone), Irgacure 500 (the combination of 50% by weight 1-hydroxy cyclohexyl phenyl ketone and 50% by weight benzophenone), Irgacure 651 (2,2-dimethoxy-2-phenyl acetophenone), Irgacure 1700 (the combination of 25% by weight bis(2,6-dimethoxybenzoyl-2,4,4-trimethyl pentyl) phosphine oxide, and 75% by weight 2-hydroxy-2-methyl-1-phenyl-propan-1-one), Irgacure 1800 (25% Bis(2,6-dimethoxybenzoyl)-2,4,4-trimethyl-pentylphosphineoxide and 75% 1-hydroxy-cyclohexyl-phenyl-ketone), Darocur 1173 (2-hydroxy-2-methyl-1-phenyl-1-propanone) and Darocur 4265 (the combination of 50% by weight 2,4,6-trimethylbenzoyldiphenyl-phosphine oxide, and 50% by weight 2-hydroxy 2-methyl-1-phenyl-propan-1-one), available commercially from Ciba-Geigy Corp., Tarrytown, N.Y.; CYRACURE UVI-6974 (mixed triaryl sulfonium hexafluoroantimonate salts) and CYRACURE UVI-6990 (mixed triaryl sulfonium hexafluorophosphate salts) available commercially from Union Carbide Chemicals and Plastics Co. Inc., Danbury, Conn.; and Genocure CQ, Genocure BOK, and Genocure M.F., commercially available from Rahn Radiation Curing. Combinations of these materials may also be employed herein. The preferred photoinitiator is a mixture of Irgacure 1800 and Darocur 1173. A particularly useful mixture comprises 50 weight percent Darocur 1173 and 50 weight percent Irgacure 1800 wherein the weight percent is the percent of the combined weight of the two photoinitiators.

The ink composition of this embodiment optionally further includes a flow promoting agent in an amount from about 0.1% to 10% of the total weight of the ink composition. In a variation, the flow promoting agent is present in an amount of about 3% of the total weight of the ink composition. Suitable flow promoting agents include Genorad 17, commercially available from Rahn Radiation Curing; and Modaflow, commercially available from Monsanto Chemical Co., St. Louis, Mo. The preferred flow promoting agent is Modaflow which is an ethyl acrylate and 2-ethylhexyl acrylate copolymer that improves the flow of the composition. Combinations of these materials may also be employed herein.

The ink composition of this embodiment also optionally further comprises an adhesion promoter in an amount of 1% to 7% of the total weight of the ink composition. In a variation, the adhesion promoter is present in an amount of about 4% of the total weight of the ink composition. Suitable adhesion promoters include Ebecryl 168 commercially available from Raducure.

In a variation of this embodiment, the ink composition includes a pigment (or pigmented composition) in an amount from about 0.1% to 40% of the total weight of the ink composition. In another variation, the ink composition includes a pigment in an amount from about 10% to 25% of the total weight of the ink composition. In yet another embodiment of the invention, the ink composition includes a pigment in an amount of about 20% of the total weight of the ink composition. Suitable pigmented compositions include UV Red Lake C pigments commercially available from General Press Colors, Ltd. (Addison, Ill.); Venus #91 pigment and Palegold #400 available from NazDar; and Al #200 pigment available from Silberline. Additional examples of suitable pigments include the metallic and flatbase pigments commercially available from EM Industries. The preferred pigment used will depend on the desired color of the paint. Combinations of these materials may also be employed herein.

In a second embodiment of the present invention, a UV curable ink composition based on an acrylic oligomer is provided. The composition of this embodiment comprises a photocurable organic composition comprising at least one acrylic oligomer, an optional pigment, and a photoinitiator. The photocurable organic composition includes a polymeric ester resin diluted with a monomer. In a variation of this embodiment, the ink composition has a viscosity from about 300 centipoise at 25° C. to about 900 centipoise at 25° C.

The ink composition of this embodiment is characterized by including an acrylic oligomer. In a variation of this embodiment, the acrylic oligomer is present in an amount from about 75% to 98% of the total weight of the ink composition. In another variation of the invention, the acrylic oligomer is present in an amount from about 75% to 85% of the total weight of the ink composition. A suitable acrylic oligomer comprises an acrylic oligomer and acrylated monomer blend. For example, a useful blend is a polymeric ester resin diluted with the monomer 1,6-hexanediol diacrylate commercially available from UCB Chemicals Corporation located in Smyrna, Ga.

Suitable photoinitiators are the same as those provided above for the first embodiment of the present invention. The photoinitiator is preferably present in an amount from about 1% to 15% of the total weight of the ink composition of the ink composition. The photoinitiator is more preferably present in an amount from about 4% to 12% of the total weight of the ink composition, and most preferably about 10% of the total weight of the ink composition. The preferred photoinitiator is a mixture of Darocure 1173 and Irgacure 1800. A particularly useful mixture comprises 50 weight percent Darocur 1173 and 50 weight percent Irgacure 1800 wherein the weight percent is the percent of the combined weight of the two photoinitiators.

Suitable pigments for this embodiment are the same as those provided above for the first embodiment of the present invention. In a variation, the pigment is present in an amount from about 0.1% to 40% of the ink composition. In another variation, the pigment is present in an amount from about 1% to 20%, and most preferably about 10%.

Finally, this embodiment optionally includes a flow agent which is a defoamer for organic systems. In variations of the invention, this defoamer is present in an amount from about 0.1% to 10% of the total weight of the ink composition. In other variations, the defoamer is present in an amount of about 0.4%. An example of a defoamer is BYK-066 commercially available from BYK Chemie located in Wellingford, Conn.

In another embodiment of the present invention, the pigment in the second embodiment may be eliminated to form a composition that provides a clear ink. In this embodiment the weight percentages and selection of ingredients is the same as for the second embodiment.

The following examples illustrate the various embodiments of the present invention. Those skilled in the art will recognize many variations that are within the spirit of the present invention and scope of the claims.

### Example 1

| | Approximate weight |
|---|---|
| Component | percent |
| Isobornyl Acrylate | 33.4 |
| Darocur 1173 (photoinitiator) | 4.5 |
| Irgacure 1800 (photoinitiator) | 4.5 |
| Ebecryl 8807 (urethane | 20.0 |
| oligomer) | |
| RX 01336 (urethane oligomer) | 11.2 |
| Ebecryl 3603 (epoxy | 20.0 |
| oligomer) | |
| Ebecryl 168 (adhesion | 3.0 |
| promoter) | |
| Modaflow (flow agent) | 3.4 |
| Total | 100.0 |

### Example 2

| | Approximate weight |
|---|---|
| Component | percent |
| Isobornyl Acrylate | 34.1 |
| Darocur 1173 (photoinitiator) | 4.05 |
| Irgacure 1800 (photoinitiator) | 4.05 |
| Ebecryl 8807 (urethane | 16.4 |
| oligomer) | |
| RX 01336 (urethane oligomer) | 9.1 |
| Ebecryl 3603 (epoxy | 13.6 |
| oligomer) | |
| Ebecryl 168 (adhesion | 4.5 |
| promoter) | |
| PC 9317 Black Pigment | 11.4 |
| Modaflow (flow agent) | 2.8 |
| Total | 100.0 |

The ink compositions of Examples 1 and 2 are formed by forming a premix of the photoinitiators—Darocure 1173 and Irgacure 1800. The premix is about a 50/50 weight percent mixture of each photoinitiator. The Isobornyl acrylate and the photoinitiator premix are introduced into a mixing container and mixed until uniform with a prop blade mixture at about 100 rpm. The Ebecryl 8807, RX 01336, Ebecryl 3603, and the Modaflow are introduced into the mixing container and initially mixed with a prop blade mixer at 500 rpm. The speed is slowly increased to about 1000 rpm. The mixing is continued until the composition is uniform while ensuring that the temperature does not exceed 100 degrees F. Finally, the Ebecryl 168 and the pigment if present is introduced into the mixing chamber and mixed until uniform at 100 rpm while ensuring that the temperature again not exceed 100 degrees F. The pigment is added as a pigment premix comprising 62.4% PC9317 and 37.6% isobornyl acrylate by weight of the combined weight of the PC9317 black pigment and the isobornyl acrylate. In example 2 the amount of isobornyl acrylate includes the amount of isobornyl acrylate in the pigment premix.

### Example 3

| | Approximate weight |
|---|---|
| Component | percent |
| IRR 303 | 90.5 |
| Darocur 1173 (photoinitiator) | 4.55 |
| Irgacure 1800 (photoinitiator) | 4.55 |
| Byk 066 (flow agent) | 0.4 |
| Total | 100.0 |

### Example 4

| | Approximate weight |
|---|---|
| Component | percent |
| IRR 303 (acrylic oligomer) | 81.5 |
| Darocur 1173 (photoinitiator) | 4.05 |
| Irgacure 1800 (photoinitiator) | 4.05 |
| Byk 066 | 0.4 |
| UV Red Lake C (red pigment) | 10.0 |
| Total | 100.0 |

The compositions of Examples 3 and 4 are formed by forming a premix of the photoinitiators—Darocure 1173 and Irgacure 1800. The premix is about a 50/50 weight percent mixture of each photoinitiator. The IRR 303, the photoinitiator premix, and the BYK 066 are introduced into a mixing container and mixed until uniform at 100 rpm ensuring that temperature not exceed 100 degrees F.

### Method for Depositing a UV Curable Ink Composition

In accordance with still another embodiment of the invention, a method is provided for depositing an ink coating on a suitable substrate. The method comprises a first step of applying an ink composition to the substrate. The ink composition utilized in this embodiment of the invention are those set forth above which include a photocurable organic composition comprising at least one acrylated oligomer; an optional pigment; and a photoinitiator. The specific descriptions of each component of the ink compositions including weight ranges is the same as those set forth above. Examples suitable substrates include plastics, metals, chloroplast, vinyls, anti-static materials, glass, PVC, and the like with superior adhesion properties when compared to solvent based systems.

The ink composition may be applied to the substrate using a number of different techniques. The ink composition may be applied, for example, by direct brush application, or it may be sprayed onto the substrate surface. It also may be applied using a screen printing technique. In such screen printing technique, a “screen” as the term is used in the screen printing industry is used to regulate the flow of liquid composition onto the substrate surface. The ink composition typically would be applied to the screen as the latter contacts the substrate. The ink composition flows through the silk screen to the substrate, whereupon it adheres to the substrate at the desired film thickness. Screen printing techniques suitable for this purpose include known techniques, but wherein the process is adjusted in ways known to persons of ordinary skill in the art to accommodate the viscosity, flowability, and other properties of the liquid-phase composition, the substrate and its surface properties, etc. Flexographic techniques, for example, using pinch rollers to contact the ink composition with a rolling substrate, also may be used. Still other application techniques include curtain coating, gravure printing, and lithographic printing.

The method includes a second step of illuminating the ink fluid-phase composition on the substrate with an ultraviolet light to cause the ink fluid-phase composition to cure into the ink coating. This illumination may be carried out in any number of ways, provided the ultraviolet light or radiation impinges upon the ink composition so that the ink composition is caused to polymerize to form the coating, layer, film, etc., and thereby cures.

Curing preferably takes place by free radical polymerization, which is initiated by an ultraviolet radiation source. The photoinitiator preferably comprises a photoinitiator, as described above.

Various ultraviolet light sources may be used, depending on the application. Preferred ultraviolet radiation sources for a number of applications include known ultraviolet lighting equipment with energy intensity settings of, for example, 125 watts, 200 watts, and 300 watts per square inch.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An ultraviolet (UV) curable ink composition consisting essentially of:
an acrylated composition comprising a polymeric ester resin diluted with 1,6-hexanediol diacrylate;
an additive component selected from the group consisting of a pigment, a flow agent, and combinations thereof; and
a photoinitiator
wherein the ultraviolet curable ink composition has a viscosity from about 300 centipoise at 25° C. to about 900 centipoise at 25° C.

2. The ink composition of claim 1 wherein:
the pigment is present in an amount from about 0.1% to about 40% of the total weight of the ink composition; and
the photoinitiator is present in an amount from about 1% to about 15% of the total weight of the ink composition.

3. The ink composition of claim 1 wherein:
the pigment is present in an amount from about 1% to about 20% of the total weight of the ink composition; and
the photoinitiator is present in an amount from about 4% to about 12% of the total weight of the ink composition.

4. The ink composition of claim 1 wherein the flow agent is present in an amount from about 0.1% to about 10% of the total weight of the ink composition.

5. The ink composition of claim 1 wherein:
the polymeric ester resin diluted with a monomer is present in an amount from about 75% to about 98% of the total weight of the ink composition;
the pigment is present in an amount from about 0.1% to about 40% of the total weight of the ink composition; and
the photoinitiator is present in an amount from about 1% to about 15% of the total weight of the ink composition.

6. The ink composition of claim 1 wherein:
the polymeric ester resin diluted with a monomer is present in an amount from about 75% to about 85% of the total weight of the ink composition;
the pigment is present in an amount from about 1% to about 20% of the total weight of the ink composition; and
the photoinitiator is present in an amount from about 4% to about 12% of the total weight of the ink composition.

7. The ink composition of claim 1 wherein the flow agent is a defoamer.

8. An ultraviolet (UV) curable ink composition consisting essentially of:
an acrylated composition comprising a polymeric ester resin diluted with 1,6-hexanediol diacrylate;
a pigment; and
a photoinitiator,
wherein the ultraviolet curable ink composition has a viscosity from about 300 centipoise at 25° C. to about 900 centipoise at 25° C.
The ink composition of claim 8 wherein:
the polymeric ester resin diluted with a monomer is present in an amount from about 75% to about 98% of the total weight of the ink composition;
the pigment is present in an amount from about 0.1% to about 40% of the total weight of the ink composition; and
the photoinitiator is present in an amount from about 1% to about 15% of the total weight of the ink composition.

9. The ink composition of claim 8 wherein:
the polymeric ester resin diluted with a monomer is present in an amount from about 75% to about 85% of the total weight of the ink composition;
the pigment is present in an amount from about 1% to about 20% of the total weight of the ink composition; and
the photoinitiator is present in an amount from about 4% to about 12% of the total weight of the ink composition.

10. A method for coating a substrate with a photocurable ink composition to form an ink coating on the substrate, the photocurable ink composition consisting essentially of:
an acrylated composition comprising a polymeric ester resin diluted with 1,6-hexanediol diacrylate;
an additive component selected from the group consisting of a pigment, a flow agent, and combinations thereof; and
a photoinitiator
wherein the ultraviolet curable ink composition has a viscosity from about 300 centipoise at 25° C. to about 900 centipoise at 25° C., the method comprising:
applying the ink composition to the substrate; and
illuminating the ink composition with a UV light sufficient to cause the ink composition to be incorporated into the ink coating by the time the composition is cured.

11. The method of claim 10, wherein the method of applying the ink composition is spraying.

12. The method of claim 10, wherein the method of applying the ink composition is screen printing.

13. The method of claim 10, wherein the method of applying the ink composition is dipping the substrate into the composition sufficiently to cause the composition to uniformly coat the substrate.

14. The method of claim 10, wherein the method of applying the ink composition is brushing.

15. The method of claim 10, wherein the method of applying the ink composition is selectively depositing to the substrate at predetermined locations.

16. The method of claim 10 wherein:
the pigment is present in an amount from about 10% to about 25% of the total weight of the ink composition; and
the photoinitiator is present in an amount from about 4% to about 12% of the total weight of the ink composition.

17. The method of claim 10 wherein:
the polymeric ester resin diluted with a monomer is present in an amount from about 75% to about 98% of the total weight of the ink composition;
the pigment is present in an amount from about 0.1% to about 40% of the total weight of the ink composition; and
the photoinitiator is present in an amount from about 1% to about 15% of the total weight of the ink composition.

18. The method of claim 10 wherein:
the polymeric ester resin diluted with a monomer is present in an amount from about 75% to about 85% of the total weight of the ink composition;
the pigment is present in an amount from about 1% to about 20% of the total weight of the ink composition; and
the photoinitiator is present in an amount from about 4% to about 12% of the total weight of the ink composition.

19. The method of claim 10 wherein the flow agent is present in an amount from about 0.1% to about 10% of the total weight of the ink composition.

20. The method of claim 10 wherein the flow agent is a defoamer.
